(19) United States
(12) Patent Application Publication
(10) Pub. No.: US 2013/0097479 A1
(43) Pub. Date: Apr. 18, 2013

(54) Electronic forms system

(71) Applicants: Jeffrey R. Zavaleta, Fort Worth, TX (US); Samuel E. Kleinman, Fort Worth, TX (US); Daniel A. Dura, Garland, TX (US); Christopher R. Barker, McKinney, TX (US); Matthew S. Oldham, Trophy Club, TX (US); Matthew W. Smith, Sachse, TX (US)

(72) Inventors: Jeffrey R. Zavaleta, Fort Worth, TX (US); Samuel E. Kleinman, Fort Worth, TX (US); Daniel A. Dura, Garland, TX (US); Christopher R. Barker, McKinney, TX (US); Matthew S. Oldham, Trophy Club, TX (US); Matthew W. Smith, Sachse, TX (US)

(73) Assignee: GRAPHIUM, LLC, Fort Worth, TX (US)

(21) Appl. No.: 13/592,721

(22) Filed: Aug. 23, 2012

Related U.S. Application Data
(60) Provisional application No. 61/526,819, filed on Aug. 24, 2011.

(51) Int. Cl. G06F 17/24

(52) U.S. Cl. CPC G06F 17/243
USPC 715/222

(57) ABSTRACT

Electronic form systems are provided. In at least certain configurations, an electronic form system includes a form definition that is utilized to generate one or more user interfaces corresponding to a form. The form definition specifies a type for each of the fields within the form. The field types may include discrete and/or abstract fields, and data may be stored locally or synchronized with a remote device. Additionally, the form definition can include any other metadata such as, but not limited to location, rendering, and formatting information. These and various other features and advantages that characterize the claimed embodiments will become apparent upon reading the following detailed description and upon reviewing the associated drawings.

### REFERENCE TO RELATED CASE

The present application claims the priority of provisional application Ser. No. 61/526,819 filed on Aug. 24, 2011, the content of which is hereby incorporated by reference in its entirety.

### BACKGROUND

Many settings utilize forms to collect data. For example, in a medical setting, a patient may first enter information such as a personal medical history into a form. A nurse may then enter other information such as weight, pulse, blood pressure, etc. Finally, a doctor may enter yet additional information such as a diagnosis or treatment plans. Similarly, in a legal setting, a client, a paralegal, and a lawyer may all enter information into forms that is used to resolve the client's legal matter. Of course, the medical and legal situations described above are merely given for illustration purposes only. Forms are not limited to any particular setting or to the collection of any particular information, and forms can be used in any setting to collect any type of information.

### SUMMARY

An aspect of the disclosure relates to electronic form systems. In at least certain configurations, an electronic form system includes a form definition that is utilized to generate one or more user interfaces corresponding to a form. The form definition specifies a type for each of the fields within the form. The field types may include discrete and/or abstract fields, and data may be stored locally or synchronized with a remote device. Additionally, the form definition can include any other metadata such as, but not limited to location, rendering, and formatting information. These and various other features and advantages that characterize the claimed embodiments will become apparent upon reading the following detailed description and upon reviewing the associated drawings.

### BRIEF DESCRIPTION OF THE DRAWINGS

FIG. 1 is a schematic diagram of a form definition.

FIG. 2 is process flow diagram of a method of generating a form definition.

FIG. 3 is a schematic diagram of an input device and a form server.

FIGS. 4-1 to 4-7 are screenshots of user interfaces that can be used in an electronic forms system.

FIG. 5 is a process flow diagram of a method of collecting form data.

FIG. 6 is a schematic diagram of an input device and form server that include a synchronization service.

FIG. 7 is a schematic diagram of a mobile device that can be used with an electronic forms system.

### DETAILED DESCRIPTION

Embodiments of the present disclosure include electronic forms systems. In some embodiments, an electronic forms system allows a user to have a similar experience to a clipboard and paper forms, but stores and manages all actions and data in a way that mimics paper as closely as possible. For instance, instead of a person filling out a paper form on a clipboard, a person illustratively enters information into an electronic version of the form using a computing device such as a smartphone, tablet computer, laptop computer, etc. The information entered into the electronic form may then be saved locally onto the computing device and/or saved remotely to a central database, server, or other remotely connected device.

Some of the examples below are directed towards medical forms. This is done merely to illustrate some specific practical embodiments. It should be appreciated that embodiments of the present disclosure are not limited to any specific implementation and that embodiments can be used in any setting or context (e.g. legal, medical, engineering, manufacturing, business, etc.). Additionally, although some embodiments may be useful for replacing or supplementing systems that use or have used paper forms, embodiments are not so limited and may be used other systems as well.

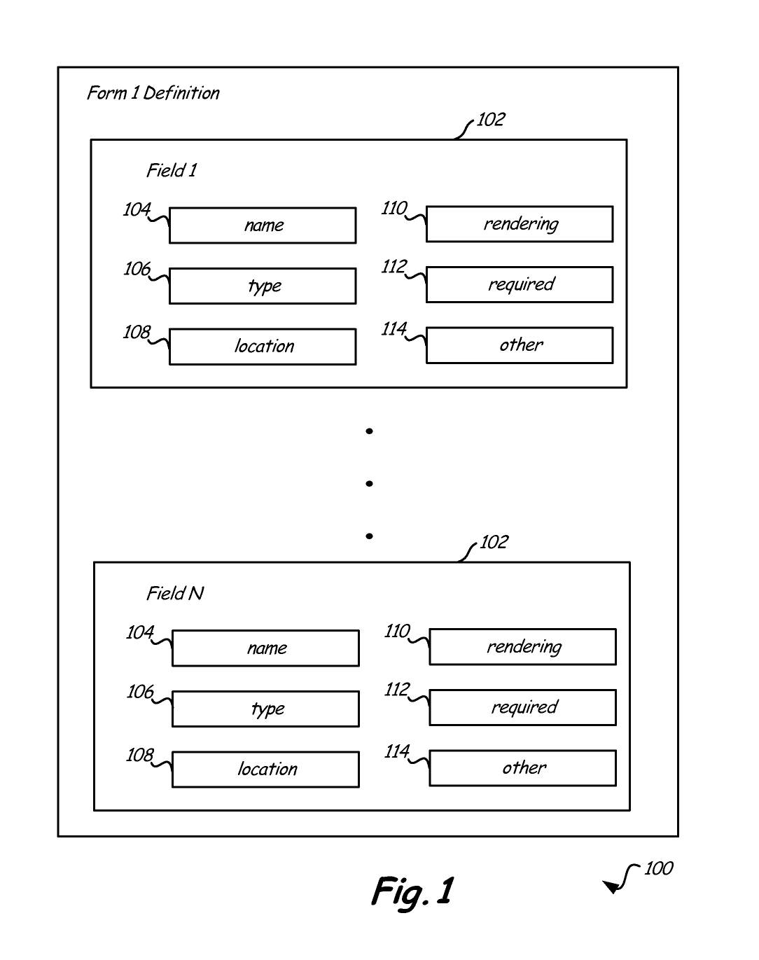

FIG. 1 is a schematic diagram of a form definition 100 that can be utilized to implement an electronic forms system. For instance, one form definition can be created and used for each form (e.g. each paper form) being replaced. Form definition 100 includes fields 102. Each field 102 optionally includes several pieces of information such as, but not limited to a name 104, a type 106, a location 108, rendering/format information 110, a required/optional status 112, and/or any other metadata 114.

In one embodiment, each field type 106 indicates whether the field is an abstract field or a discrete field. For an abstract field, data is entered using freehand handwriting, and the system captures data about what was written (e.g. a bitmap of the drawing in pixel format, information about strokes, etc.). In such a situation, the system does not need to know anything about an actual value of the data. Instead, the system simply captures the handwriting, and may use some kind of recognition (e.g. handwriting recognition) on the captured input.

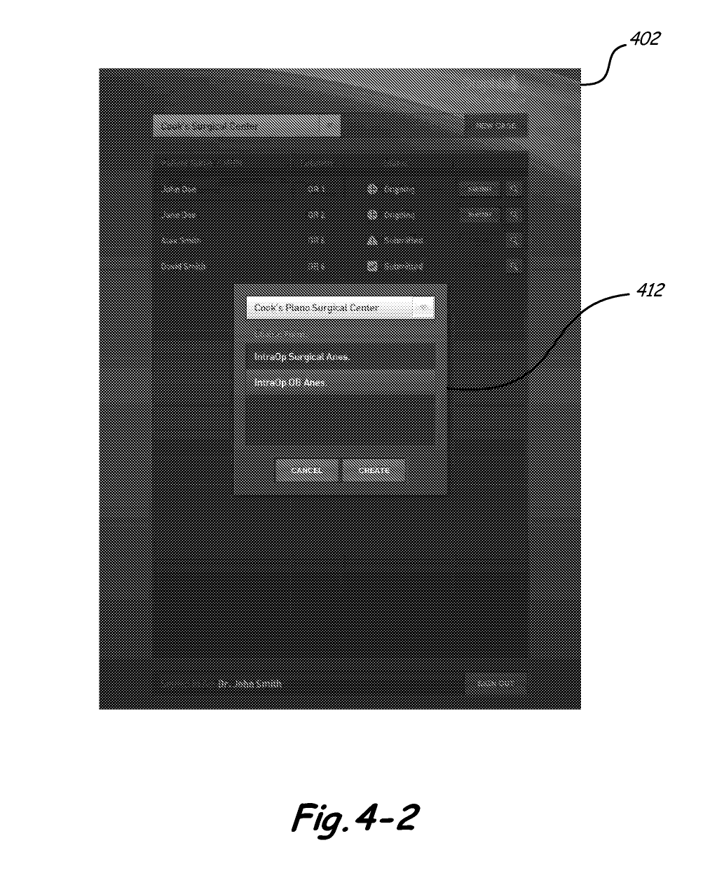

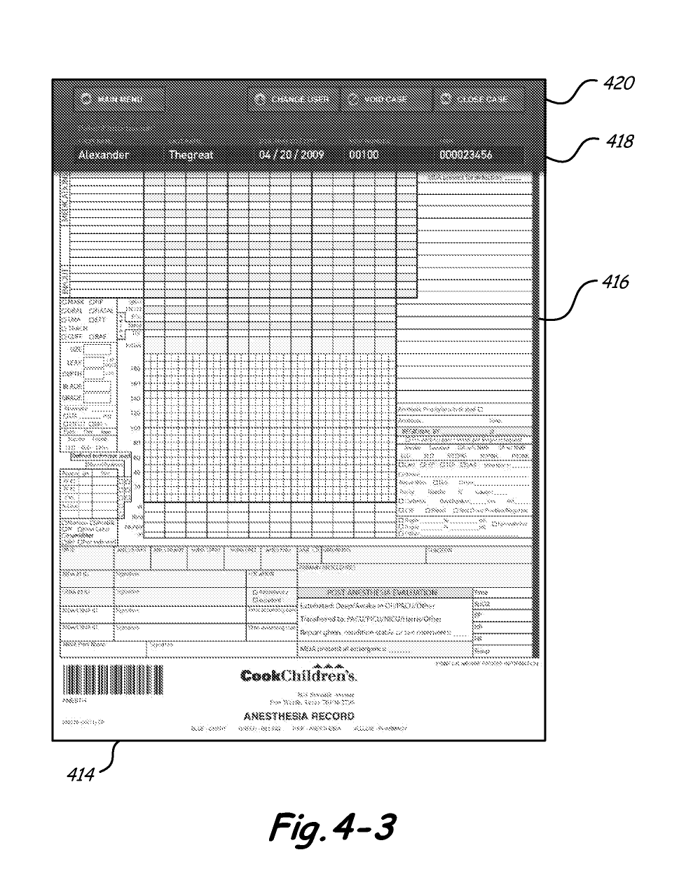

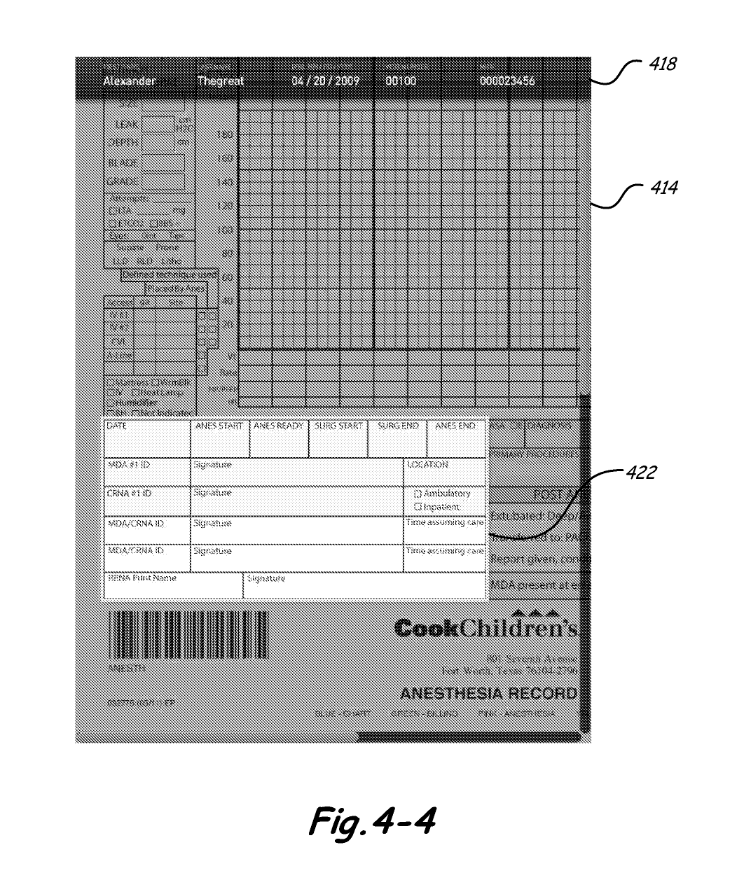

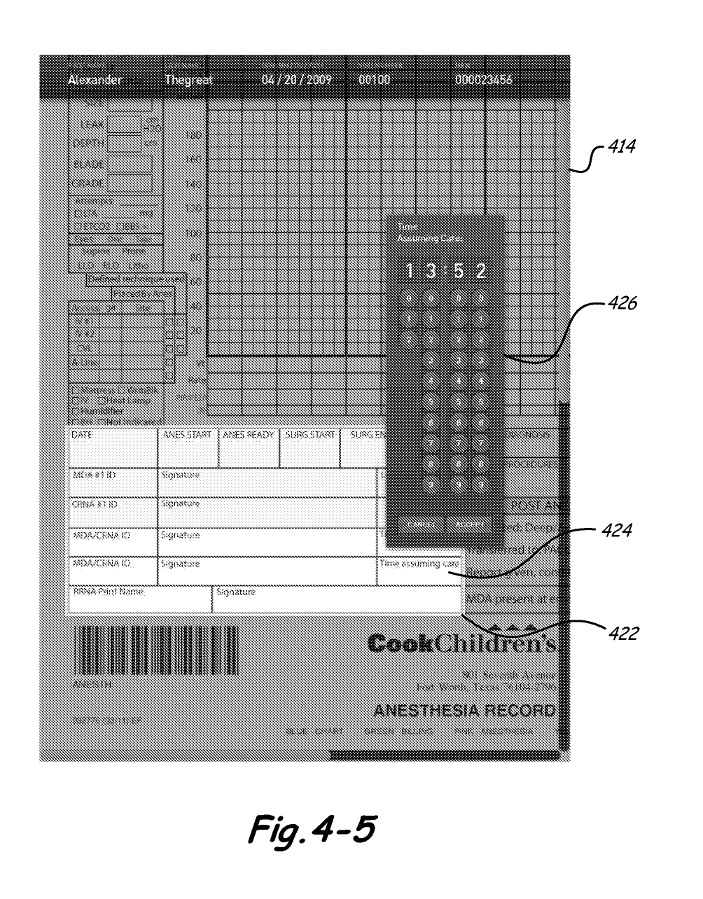

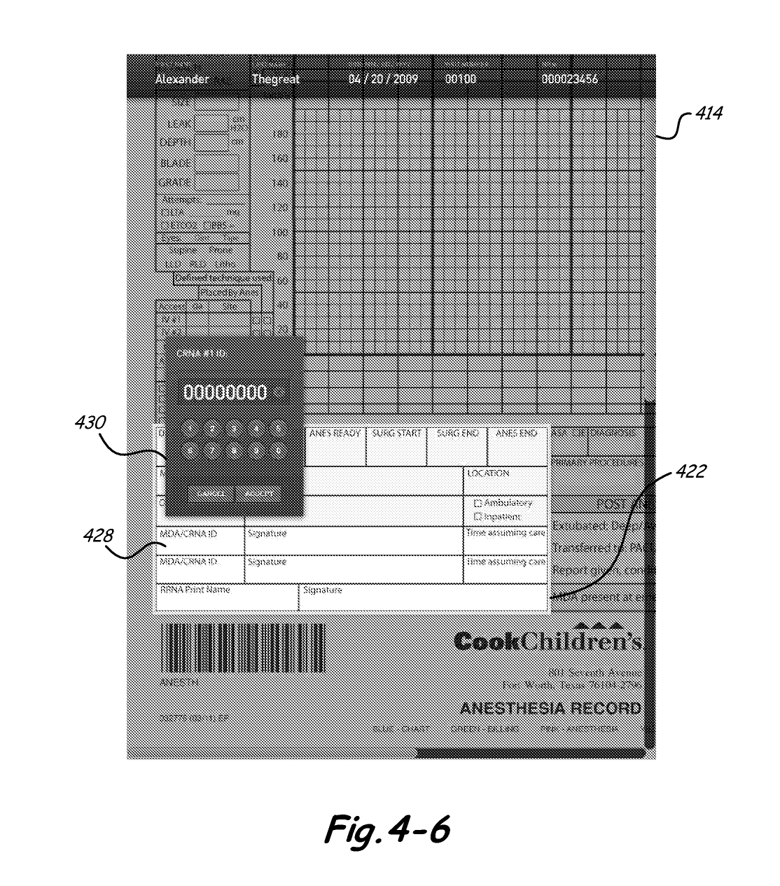

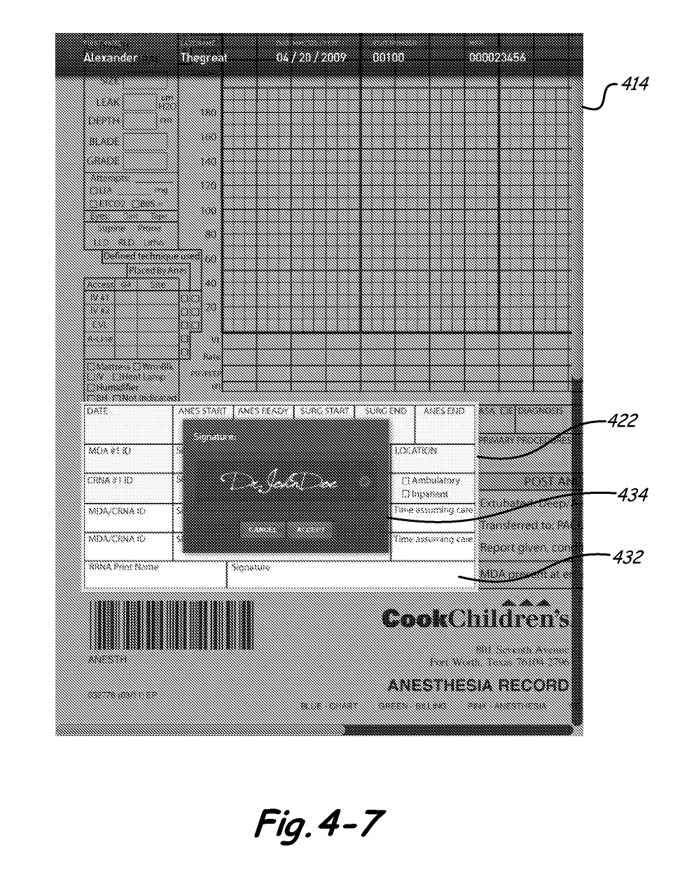

For discrete fields, each field holds a distinct value such a number, date, ID, character string, etc. In some embodiments, an input component is generated to aid a user in entering information into the field. For example, FIGS. 4-5 and 4-6 show embodiments of input components that can be used to assist a user in entering information into a discrete field of a form.

The field location 108 can specify a location of the field on the form. For instance, the field location 108 can specify the corners of a field using a Cartesian coordinate system (e.g. x, y coordinates). The location information may be derived from an image of a paper form such that the electronic version will resemble the paper form.

The rendering/format information 110 can specify how to render or format data. For instance, a date can be displayed as 12-01-2011 or Dec. 1, 2011. The required/optional status identifies whether or not data must be entered for the field for the form to be considered valid. A patient name could be required information for example, while an email address could be optional.

Other metadata 114 represents the fact that a field can include any other metadata as desired to implement a form. The metadata described above is merely given to illustrate one possible implementation. Additionally, it should be noted that a form definition can be implemented using XML. Embodiments are not however limited to any particular implementation and can use any appropriate technology.

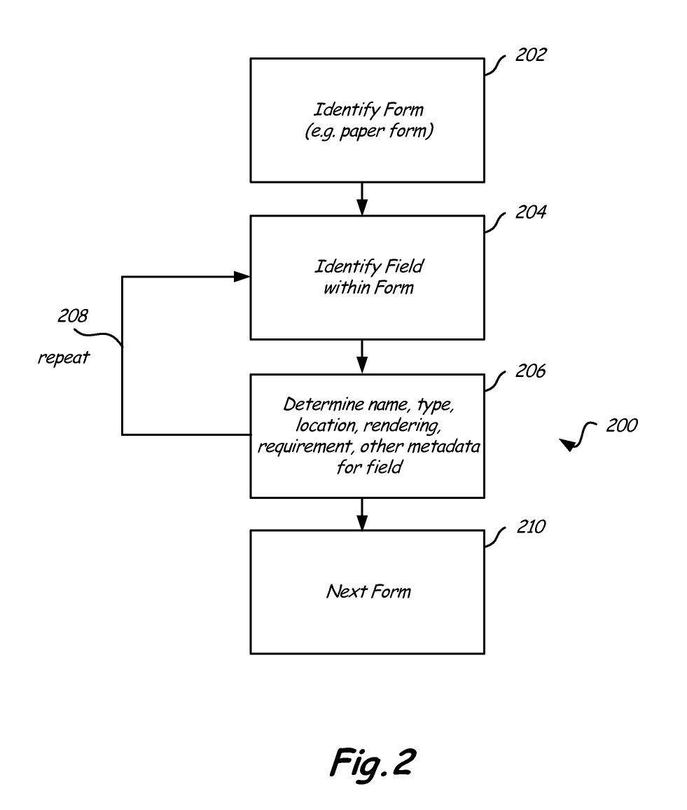

FIG. 2 illustrates one method of generating a form definition 200. At block 202, a form is identified, and at block 204, a field within the form is identified. Information about the field is then determined at block 206. For example, a field name, type, location, rendering/formatting information, required/optional status, and any other metadata can be determined. At line 208, the process is repeated for additional fields within the form. Once all of the fields have been processed, the method may be repeated for a next form at block 210.

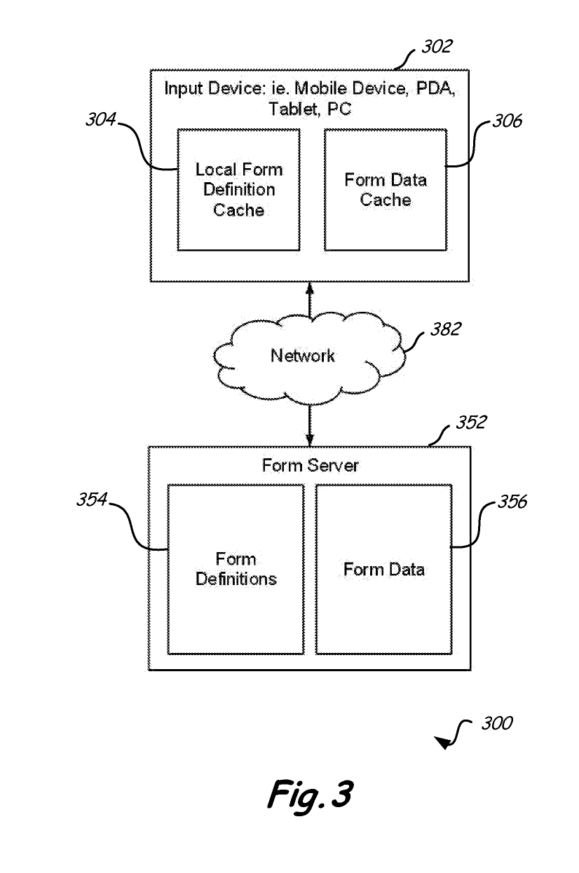

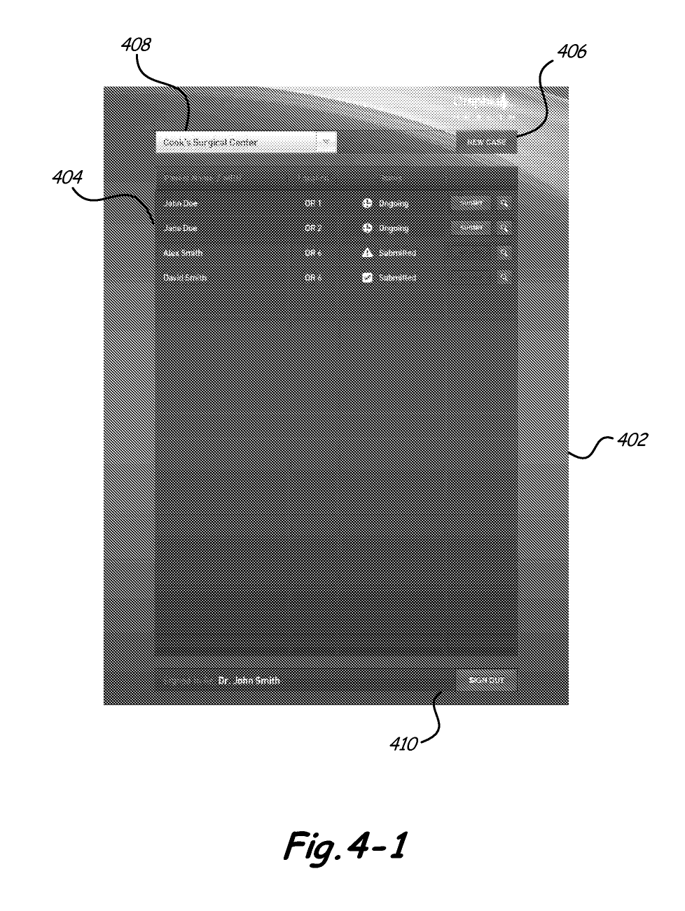

FIG. 3 shows one illustrative example of an operating environment 300 in which certain embodiments of electronic forms can be used. Environment 300 includes an input device 302 (e.g. a mobile device, a PDA, tablet, PC, etc.) and a form server 352. The input device 302 and server 352 may be communicatively coupled through a network 382.

Former server 352 stores form definitions 354 and form data 356. In one embodiment, when data is stored on the server 352, it is stored in key/value pairs that relate to the form definition and form version. This allows the system to manage data for multiple forms and form versions. As is shown in FIG. 3, form definitions 354 may be stored separate from form data 356. The form data 356 can be stored in abstract name/value pairs, which allows creation of multiple form types without major data architecture changes.

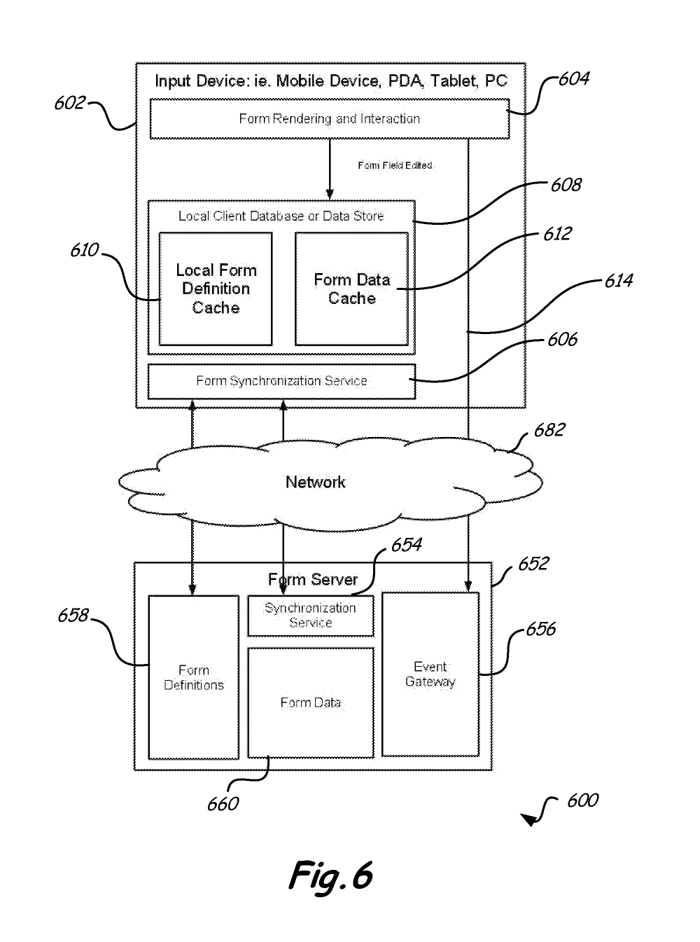

A user of input device 302 identifies a form that he or she would like to use. The form definition is downloaded to a local form definition cache 304 of the input device. The user is then able to interact with the form and to utilize it to collect data. The form data may be stored in a local form data cache 306, which may then be uploaded or synchronized to the server form data 356. In one implementation, all data is synchronized between input device 302 and the server 352 to help enable offline form creation using the local cache of the form data 306. Further details of synchronization options are discussed in relation to FIG. 6.

FIGS. 4-1 to 4-7 show examples of user interfaces that can be used in an electronic form system. The examples are given merely for illustration purposes only, and embodiments of the present disclosure are not limited to any particular forms. For example, as previously mentioned, forms are not limited to only medical settings and can instead be used in any setting or context.

FIG. 4-1 shows an example of a patient selection user interface 402. Interface 402 has a patient section 404 that lists a number of patients. For each patient, section 404 lists a name or medical record number, a location, and a status. Interface 402 also has a new case button 406 that allows a user to enter a new patient if needed.

Interface 402 may also include a facility selection component 408 and a sign in/sign out component 410. In an embodiment, a user can use component 408 to select between multiple facilities. Once a particular facility is selected, the patients associated with that facility are shown in section 404. Similarly, sign in/sign out component 410 enables a particular user (e.g. a particular care take) to log into the system. Once a particular user is logged in, the patients associated with that care taker may be shown in section 404. Accordingly, the list of patients in section 404 can be selectively displayed for the appropriate facility and/or care taker.

FIG. 4-2 shows an example of a forms selection user interface 412. Interface 412 is illustratively displayed once a patient is selected using patient selection user interface 402. Interface 412 lists forms that can be selected for the particular patient. For instance, in the example shown in the figure, the two forms that can be selected are an “IntraOp Surgical Anes.” form and an “IntraOp Anes.” form. Obviously, any number of forms can be displayed in interface 412 for selection. Once one of the forms is selected (e.g. by highlighting), it is created using the “create” button. Additionally, interface 412 may include options for choosing a facility and for cancelling the selection process.

FIG. 4-3 shows an example of a form user interface 414. Interface 414 is illustratively displayed once a form is selected using interface 412 in FIG. 4-2. Interface 414 includes a form section 416 that displays an image of the selected form. In an embodiment, the image is the same or at least resembles a corresponding paper form that is being replaced by the electronic form. Interface 414 may also include a patient information section 418 that lists information for the patient, and a navigation bar 420 that enables a user to navigate within the system. For example, navigation bar 420 may include options for returning to the main menu, to change the user, to void a case, and to close a case.

FIG. 4-4 shows an example of a form region 422. In an embodiment, to be able to more efficiently navigate an electronic version of a form, forms are divided into regions. When a user first opens a form (e.g. in FIG. 4-3), they are shown the entire form. In the form definition, the regions are defined as abstract polygons that are then rendered in the client application. This allows a user to select a region on the form, which will be zoomed into, and then the user will be able to select an individual field for editing. The selected region can also be emphasized by using shading, blurring, or any other effect to highlight the selected region.

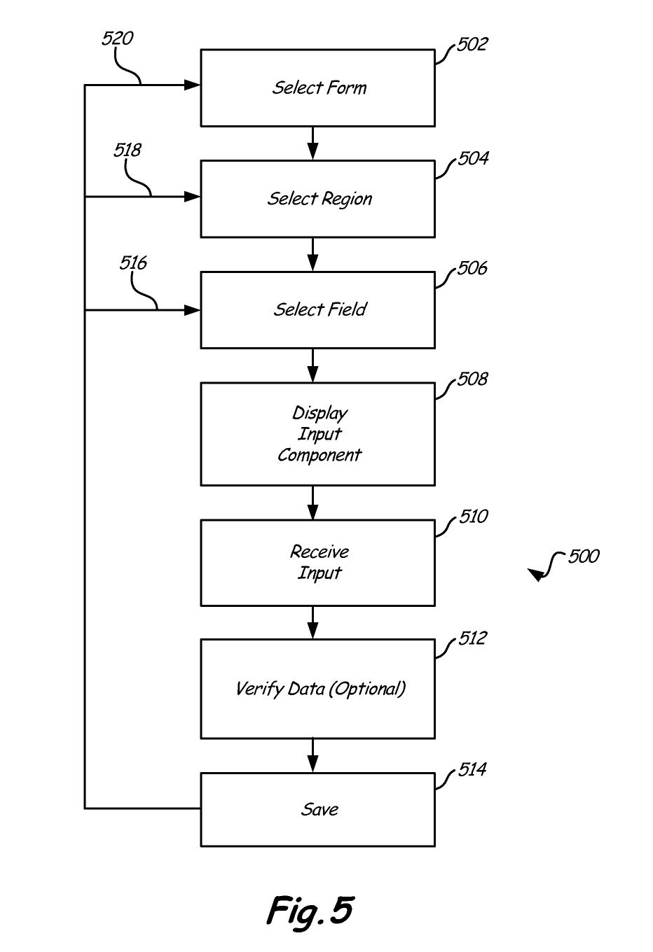

FIG. 4-5 shows an example of an input component 426 for a discrete field. In the figure, the field “Time assuming care” 424 has been selected from the highlighted region 422 of form 414. In an embodiment, the input component 426 is dependent on the type of field (e.g. discrete or abstract), and may also be further tailored to assist a user in entering information in the correct format. For example, in the example shown in FIG. 4-5, the field 424 is looking for a military time to be input in HH:MM format. Accordingly, input component 426 is configured to receive information in the correct format.

FIG. 4-6 shows an example of another input component 430 for a discrete field. In the figure, the field “MDA/CRNA ID” 428 has been selected from the highlighted region 422 of form 414. The input component 430 is again tailored to assist a user in entering information in the correct format. It should be noted that input component 426 in FIG. 4-5 and input component 430 in FIG. 4-6 are both for discrete field types, however the specific layouts and configurations of the input components are specific for the particular field selected.

FIG. 4-7 shows an example of an input component 434 for an abstract field. In the figure, the field “Signature” 432 has been selected from the highlighted region 422 of form 414. As can be seen in the figure, the input component 434 is configured to receive a freehand hand-written signature. Accordingly, FIGS. 4-5 and 4-6 show examples of input components configured for discrete fields, and FIG. 4-7 shows an example of an input component configured for an abstract field.

FIG. 5 shows a process flow diagram of a method 500 of collecting form data. At block 502, a form is selected. Once a form is selected, a region within the form is selected at block 504. Then, a particular field within the region is selected at block 506. Based on the type of field, an input component specific for the field type is displayed at block 508. Input is received at block 510 using the input component. At blocks 512 and 514, the data is optionally verified and is saved. The process may then be repeated at various points depending upon the needs of the user. For instance, the process can be repeated by selecting another field at line 516, by selecting another region at line 518, or by selecting another form at line 520.

FIG. 6 shows another illustrative example of an operating environment 600 in which certain embodiments of electronic forms can be used. Environment 600 includes an input device 602 that is communicatively coupled to a server 652 through a network 682.

Input device 602 optionally includes a form rendering and interaction module 604, a form synchronization service 606, and a local database or data store 608. Data store 608 may include local form definition cache 610 and form data cache 612.

Form server 652 optionally includes a synchronization service 654, an event gateway 656, a forms definition database or data store 658, and a form data database or data store 660.

In an embodiment, form data is synchronized between the input device 602 and the server 652 where the form data 660 is stored in key value pairs along with the form definition 658 and other relevant information. This information is constantly synchronized with a local database 612 on the input device 602. Should a connection with the server 652 be lost through hardware defect, network corruption, or system downtime, the input device 602 will continue to save form changes to the local database 612. Should the connection be restored, all local data 612 will be synchronized with the server 652 using synchronization service 606/654.

Additionally, when an action occurs on a form, if a network connection is present, the input device 602 will send event messages 614 in real time to an event gateway 656 of the server 652, which it can then share with a third-party to notify of changes to the form. This allows events to be propagated, even though the form data may not have been synchronized yet.

Once a user wants to perform any actions on the form such as changing its state for workflow, the server 652 at that time commit all the resources into the database and perform any additional actions that the system requires.

In another embodiment, in an attempt to allow a more paper-like workflow for sharing of forms between individuals, the system allows a user to check in and check out forms for editing. All form data is stored in a temporary cache in the middle tier (e.g. form server) which is synchronized with the client application (e.g. input device) when it is connected.

If a user creates a form, it is inherently checked out to them. Signifying that they have completed any edits they wish to make, they can check in the form which makes it available to other users to check out. Once a form is checked out, the client application synchronizes its local database to hold the information that is in the middle tier and confirms to the middle tier that the new user has control of the form. This is analogous to putting the paper form on someone else's clipboard. If a user loses a connection while a form is checked out, they continue to maintain control over that form until they have a connection and can check it back in.

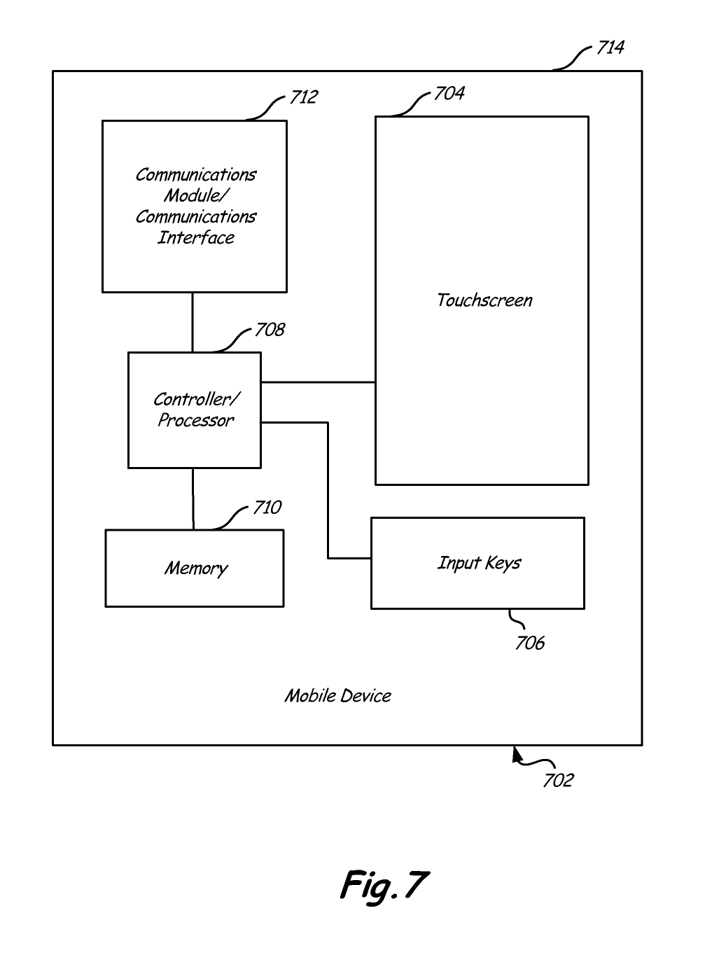

FIG. 7 is a block diagram of one example of a mobile device 702. Certain embodiments of the present disclosure may be implemented utilizing a mobile device such as the one shown in FIG. 7 (e.g. input devices 302 in FIGS. 3 and 602 in FIG. 6). Embodiments are not however limited to any particular type or configuration of device and may be implemented utilizing devices different than the one shown in the figure. Mobile device 702 illustratively includes a touchscreen 704, input keys 706, a controller/processor 708, memory 710, a communications module/communications interface 712, and a housing/case 714.

Touchscreen 704 illustratively includes any type of single touch or multitouch screen (e.g. capacitive touchscreen, vision based touchscreen, etc.). Touchscreen 704 is able to detect a user's finger, stylus, etc. contacting touchscreen 704 and generates input data (e.g. x and y coordinates) based on the detected contact. Input keys 706 include buttons or other mechanical devices that a user is able to press or otherwise actuate to input data. For instance, input keys 706 may include a home button, a back button, 0-9 number keys, a QWERTY keyboard, etc.

Memory 710 includes volatile, non-volatile or a combination of volatile and non-volatile memory. Memory 710 may be implemented using more than one type of memory. For example, memory 710 may include any combination of flash memory, magnetic hard drives, RAM, etc. Memory 710 stores the computer executable instructions that are used to implement the applications and/or user interfaces described above. Controller/processor 708 can be implemented using any type of controller/processor (e.g. ASIC, RISC, ARM, etc.) that can process user inputs and the stored instructions, and communications module/communications interface 714 transmits and receives information.

Finally with respect to FIG. 7, the controller housing 714 can be any suitable housing. In one embodiment, housing 714 has a form factor such that mobile device 702 is able to fit within a user's hand. Housing 714 may however be larger (e.g. tablet sized) and is not limited to any particular form factor.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An electronic form system comprising:
a form definition that identifies a plurality of fields within a form, and that specifies a type for each of the fields; and
a processor that is a component of a computing device that utilizes the form definition to generate one or more user interfaces corresponding to the form.

2. The system of claim 1, wherein a portion of the fields corresponds to a discrete type, and another portion of the fields corresponds to an abstract type.

3. The system of claim 1, wherein the system includes a local data store that saves form data.

4. The system of claim 1, wherein the system includes a remote data store that saves form data.

5. The system of claim 1, and further comprising:
an input component that is generated based at least in part on the type of field selected.

6. The system of claim 1, wherein at least some of the fields are grouped together to form different regions of the form.

7. The system of claim 1, wherein the form definition includes location and rendering information.

8. A method comprising:
accessing a form definition that includes metadata for a plurality of fields within a form; and
utilizing a processor that is a component of a computing device to generate an electronic version of the form based at least in part on the form definition.

9. The method of claim 8, wherein the metadata includes a field type.

10. The method of claim 8, wherein the metadata includes a field location.

11. The method of claim 8, wherein the metadata includes rendering information.

12. The method of claim 8, wherein the metadata includes information identifying whether a field is required or optional.

13. The method of claim 8, and further comprising:
storing and accessing form definitions for additional forms.

14. An electronic form system comprising:
a user interface that displays an electronic version of a form that is generated based at least in part on a form definition.

15. The system of claim 14, and further comprising:
an input component configured to receive data for a discrete field.

16. The system of claim 14, and further comprising:
an input component configured to receive data for an abstract field.

17. The system of claim 14, and further comprising:
a region that includes multiple fields within the form.

18. The system of claim 14, and further comprising:
a synchronization service.

19. The system of claim 14, and further comprising:
a data store that stores multiple form definitions.

20. The system of claim 14, and further comprising:
a data store that stores form data.
